(19) United States
(12) Patent Application Publication
(10) Pub. No.: US 2004/0105399 A1
(43) Pub. Date: Jun. 3, 2004

(54) Survivable call box

(76) Inventors: Thomas G. Robertazzi, Mastic, NY (US); Sangjin Hong, South Setauket, NY (US); Kenneth Short, Setauket, NY (US)

Correspondence Address: RIVKIN RADLER LLP, EAB PLAZA, UNIONDALE, NY, 11556-0111, US

(21) Appl. No.: 10/301,350

(22) Filed: Nov. 20, 2002

(51) Int. Cl. H04B 7/00

(52) U.S. Cl. 370/310

(57) ABSTRACT

A robust radio device and method of communication capable of performing in extreme environments such as during a disaster are disclosed. The robust radio device and method of communication include a radio enclosed in a durable enclosure which is capable of participating in an ad-hoc network.

### CROSS REFERENCE TO RELATED APPLICATIONS

Not Applicable

### FIELD OF THE INVENTION

This invention relates generally to a communication system capable of performing in extreme environments such as during a disaster.

### BACKGROUND OF THE INVENTION

Communication in buildings during emergencies, such as fires or collapse, has historically been a problem. Analog radios, typically used by emergency personnel, cannot penetrate through more than several floors or walls. Even radio systems using ultra-wideband, or digital technology have proven to be only marginally, if any, better at penetrating the concrete and steel used as flooring and wall material in certain buildings. One solution to this problem has been to install so called “leaky-lines” into buildings. These “leaky-lines” (for example, coaxial cable whose shielding has been breached) act as a long antenna system, picking up radio signals and carrying them to amplifying repeaters that radiate the signals from the “leaky-line.” The “leaky-line” solution, however, can be rendered non-functional in extreme environments, which may be experienced during an emergency or disaster. In such case, the irony is that the system fails in the situation where it needed most, endangering the lives of the building's occupants and emergency response personnel.

The faults of a “leaky-line” system were demonstrated in the twin towers of the World Trade Center in New York on Sep. 11, 2001. On this fateful day, jetliners crashed into each of the towers of the World Trade Center, sparking intense fires. The fires, almost instantaneously, destroyed the coaxial cables forming the backbone of the “leaky-line” system. Falling debris also damaged the “leaky-line” system's repeater, which was located in an adjacent building. More than 300 firefighters and other emergency response personnel lost their lives when the buildings collapsed. It was reported at the time that an order had been given to evacuate the buildings but that many of the heroic emergency response personnel did not receive the order because of the failure of the “leaky-line” system.

The present invention combines ad-hoc networking technology with durable housing technology to provide a survivable communication device and system that can survive under extreme ambient conditions.

### The Prior Art

Interest in ad-hoc networking technology has intensified recently due to the growth of mobile communications. An ad-hoc network comprises a plurality of radio hosts each being able to communicate with its neighboring radio hosts. In such a network, each radio host acts as a router forwarding packets of information from one radio host to another.

Ad-hoc radio networks are well suited for mobile communications since the routing of the packets of information can change depending on the relative locations of the radio hosts. Many protocols have been developed to efficiently modify routing paths when necessitated by changes in the interconnectivity between mobile radio hosts caused by the relative migration of the radio hosts in an ad-hoc radio network. These protocols may be hierarchical or nonhierarchical in structure, and synchronous or asynchronous in operation. Examples of such protocols include: the Link Cluster Algorithm, Distributed Evolutionary Algorithm, Replicated Port Matching Algorithm, Vote Based Port Matching Algorithm and Layernet. Recently more sophisticated protocols have been developed, including: Ad hoc On-demand Distance Vector Routing Algorithm (AODV), Dynamic Source Routing (DSR), Mobility Status Table Based Routing, Location-Aided Power-Aware Routing, TORA and ZRP. These protocols are generally known to one of ordinary skill in the radio communications art.

Radio hosts installed at various locations of a building can route information to at least one of several other radio hosts within the reach of their respective radio signals. If a radio host is rendered inoperable, for instance by an extreme fire or a collapse, the routing path of the information is modified, providing for the continued communication between the operable radio hosts.

Durable enclosures have been developed to protect data recorders in the event of airline disasters. Durable enclosures are capable of shielding their contents from extreme ambient conditions such as the high impact forces, shock, and mechanical penetration forces that may accompany an airline crash. Durable enclosures are also capable of shielding their contents from extreme temperatures, such as those attained when large quantities of aviation fuels burn. Groenewegen teaches a durable enclosure in U.S. Pat. No. 4,944,401, which is incorporated herein by reference.

### SUMMARY OF THE INVENTION

The invention comprises a radio host, capable of participating in an ad-hoc network, housed in a durable enclosure that shields the contents from extreme ambient conditions.

In an embodiment of this invention, interior radio hosts, housed in durable enclosures, are permanently mounted on each floor of a high-rise building or in proximal rooms in other large buildings. These interior radio hosts provide intra-building voice and data communication via an ad hoc network. Additional radio hosts, which may or may not be housed in a durable enclosure, may join the network when brought in sufficient proximity to the building. For example, emergency response personnel may bring an additional radio host to a location near the building. This additional radio host then becomes part of the ad-hoc network permitting communication with the interior radio hosts. Since each of the additional radio hosts may join the network, all emergency response personnel who enter the building with additional radio hosts can maintain contact with other emergency response personnel, regardless of the number of floors or distance between them.

In another embodiment, each of the interior radio hosts is in communication with ambient-environment sensors and detectors in its immediate location. The interior radio hosts can broadcast the data received from the ambient-environment sensors and detectors over the ad hoc network. In this embodiment, ambient-environmental conditions such as temperature, motion, or the presence of smoke, hazardous chemicals, or contaminants are communicated over the network for use by emergency response personnel.

For example, in an embodiment, smoke and temperature sensors mounted on each floor of a high-rise building are in communication with a radio host on that floor. If a fire should break out, for example, on the eighty-fifth floor of the building, information regarding the presence of smoke and the temperature can be transmitted over the ad-hoc network to emergency response personnel and other occupants of the building. Such information can be used to direct evacuation of the building or to determine the safety of rescue operations.

In another embodiment of this invention, the interior radio hosts comprise robust voice recognition software, providing for hands free operation by building occupants. In emergency situations, it may not be possible or practical for a building occupant to manually operate a radio host in order to communicate over the ad-hoc network. For instance, an occupant may be injured or trapped and unable to reach the interior radio host, or an occupant may be preoccupied assisting other occupants who are injured. The robust voice recognition software permits an occupant to operate the radio host with voice commands in situations where manual operation is not possible.

In another embodiment, video cameras are mounted in proximity to each of the interior radio hosts and are in communication with them. Video images of the environment near the interior radio hosts may be communicated over the ad-hoc network to emergency response personnel or other occupants of the building.

A spatial location device is also anticipated in an embodiment of this invention. The spatial location device facilitates locating an interior radio host in the event of a building collapse. Simple devices such as those which emit loud audible sounds or which flash a strobe light may be used. Other devices, which take advantage of the radio host's transmitting capability, are also envisioned. As an example, the radio host may comprise a global positioning system receiver and data from this receiver may be transmitted by the radio host.

The aforementioned embodiments are examples of many possible embodiments of this invention. Other embodiments of this invention are also envisioned including, but not limited to, those described in the detailed description below.

### DESCRIPTION OF THE DRAWINGS

FIG. 1 is an illustration of a radio host and temporary power supply within durable enclosure.

FIG. 2 illustrates the arrangement of radio hosts in a preferred embodiment of this invention.

### DETAILED DESCRIPTION

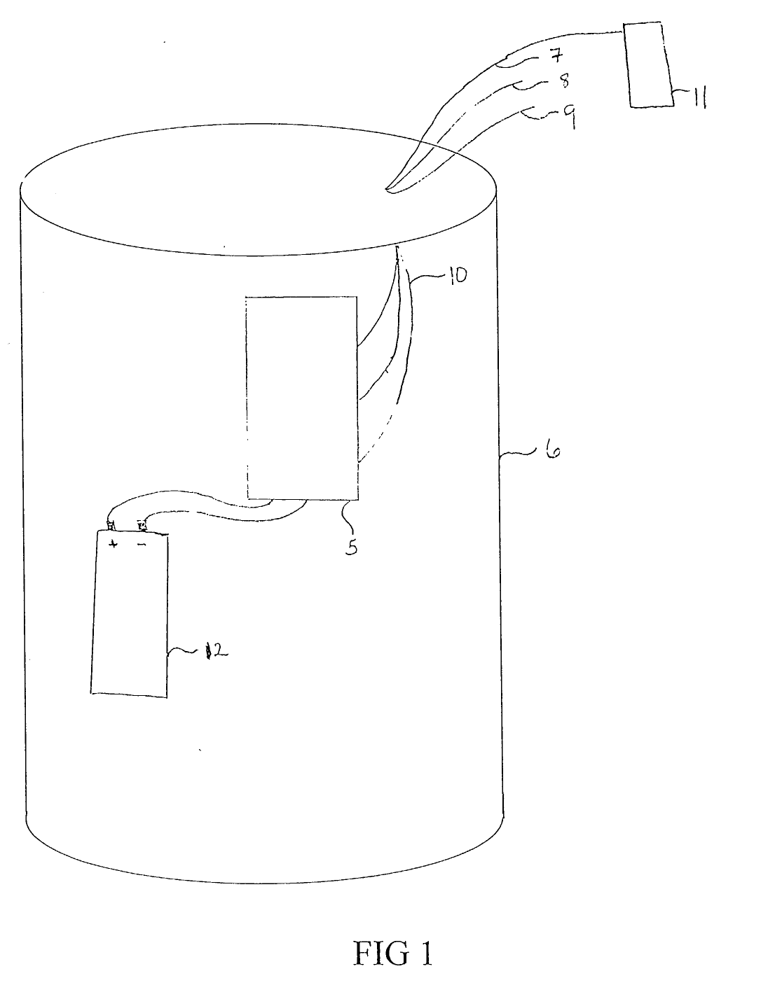

Referring now to the drawings, therein is illustrated a new survivable call box system. Referring more particularly to FIG. 1, in an embodiment of this invention at least two of the interior radio hosts are housed in durable enclosures. The durable enclosures are specifically designed to protect the radio host from physical damage in the event of extreme ambient conditions as might be experienced in a fire or during a collapse of the structure or other emergency or hazardous situations. An interior radio host (5) is enclosed in a durable enclosure (6) and is interconnected to a power line (7), signal lines (8), and sensor lines (9) through wired or wireless links. When interconnected by wired links (10), such links pass outwardly from the durable enclosure (6) for interconnection to an external power supply (11) and may connect to one or more of the following: a microphone, a speaker, a camera, or ambient-environment sensors. The radio host may also be interconnected to a temporary rechargeable power supply (12), such as a battery. Such temporary rechargeable power supply (12)is enclosed in the durable enclosure (6).

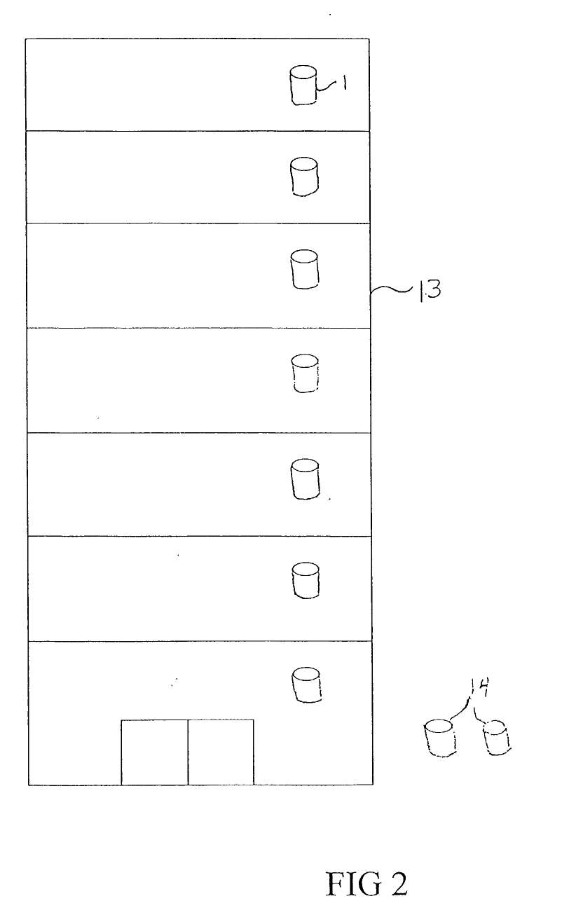

Referring now to FIG. 2. This figure depicts interior radio hosts housed in a durable enclosures (1) permanently affixed on each floor of a high-rise building. Each interior radio host is in sufficient proximity to at least two other interior radio hosts so that its radio signals can be received by the at least two other interior radio hosts. The interior radio hosts are capable of forming an ad-hoc network. Additional radio hosts (14) can join the ad hoc network when brought within sufficient proximity to the building to permit communication with at least one of the interior radio hosts.

In an embodiment of this invention, the radio hosts initiate communication via the ad hoc network when the external power supply (12) to an interior radio host (5) fails. Other triggers are also contemplated to initiate communication over the ad-hoc network. For instance, the detection of smoke or hazardous chemicals or hazardous ambient conditions may trigger a radio host to transmit pre-determined communications via the ad hoc network. Communication may also be initiated by directive by emergency response personnel through the use of a switchboard or otherwise or by an occupant of the building near an interior radio host.

In another embodiment, the interior radio hosts of this invention comprise voice recognition software, permitting hands free operation by an injured person in the building. The interior radio hosts may also comprise a means for announcing evacuation and other information to building residents. Such information may be announced in audible or visual formats or both. The information may be information which is contemporaneously broadcast over the ad-hoc network, or prerecorded information which is activated by a signal received over the ad-hoc network.

In a further embodiment of this invention, ambient-environment data can be broadcast from an interior radio host to emergency response personnel. Such data may include the location of the interior radio host, the temperature, the presence of smoke, fire, hazardous chemicals, biological or other contaminants or irritants at that location. In another embodiment, software provides a user-friendly interface for emergency response personnel to interpret the data.

Although the description above contains many specificities, these should not be construed as limiting the scope of the invention but merely providing illustrations of some of the embodiments of this invention. Thus the scope of the invention should be determined by the appended claims and their equivalents, rather than only by the examples given above.

What is claimed is:

1. A communication device for a building comprising: a radio host capable of participating in an ad-hoc network, said radio host being housed in a durable enclosure.

2. The communication device of claim 1 wherein said radio host is capable of both broadcasting and receiving communications over said ad-hoc network.

3. The communication device of claim 2 further comprising a temporary power source housed in the durable enclosure.

4. The communication device of claim 3 further comprising a microphone and a speaker, wherein said microphone and said speaker are connected to said radio host by at least one signal line.

5. The communication device of claim 4 further comprising a temperature sensor connected to said radio host by at least one sensor line.

6. The communication device of claim 4 further comprising a spatial location determination device for identifying the location of said radio host.

7. The communication device of claim 2 further comprising voice recognition software for hands-free operation of said radio host.

8. A communication system comprising: at least three radio hosts capable of participating in an ad-hoc network wherein at least one of said three or more radio hosts is housed in a durable enclosure.

9. The communication system of claim 8 wherein the at least one of said three or more radio hosts comprises voice recognition software for hands-free operation of said radio host.

10. The communication system of claim 8 further comprising a software program for analyzing data broadcast by the at least one of said three or more radio hosts.

11. The communication system of claim 8 wherein the ad hoc network is initiated when an external power supply to at least one of the at least one of said three or more radio hosts fails.

12. The communication system of claim 8 further comprising means for announcing information over said ad-hoc network.

13. A communication device for a building which comprises:
a. at least three radio hosts wherein at least one of said at least three radio hosts is housed in a durable enclosure; and,
b. means for the radio hosts to form an ad-hoc network.

14. The communication device of claim 13 further comprising means for sensing ambient-environment conditions so that information regarding said ambient-environment conditions may be broadcast over said ad-hoc network.

15. The communication device of claim 13 further comprising means for operating the at least one of said at least three radio hosts using voice commands.

16. The communication device of claim 13 further comprising means for determining the location of the at least one of said at least three radio hosts.

17. The communication device of claim 13 further comprising means to supply power to the at least one of said at least three radio hosts when an electrical supply to the building is lost
